(19) United States
(12) Patent Application Publication
(10) Pub. No.: US 2017/0295551 A1
(43) Pub. Date: Oct. 12, 2017

(54) CELL SYNCHRONIZATION SIGNALS

(71) Applicant: QUALCOMM Incorporated, San Diego, CA (US)

(72) Inventors: Bilal SADIQ, Basking Ridge, NJ (US); Navid ABEDINI, Raritan, NJ (US); Tao LUO, San Diego, CA (US); Juergen CEZANNE, Ocean Township, NJ (US); Sundar SUBRAMANIAN, Bridgewater, NJ (US); Muhammad Nazmul ISLAM, Edison, NJ (US); Ashwin SAMPATH, Skillman, NJ (US); Krishna Kiran MUKKAVILLI, San Diego, CA (US)

(21) Appl. No.: 15/437,171

(22) Filed: Feb. 20, 2017

Related U.S. Application Data
(60) Provisional application No. 62/319,286, filed on Apr. 6, 2016.

(51) Int. Cl. H04W 56/00; H04J 11/00

(52) U.S. Cl. CPC H04W 56/001; H04J 11/0073; H04J 11/0076; H04J 2011/0096

(57) ABSTRACT

Certain aspects of the present disclosure relate to methods and apparatus for generating synchronization signals for cell synchronization. Certain aspects of the present disclosure provide a method for wireless communication. The method generally includes determining a symbol index for transmitting a sequence; determining an amount of cyclical shift in one of a frequency domain and a time domain to apply to the sequence, wherein the amount of cyclical shift in the frequency domain is based on the sequence and the symbol index; shifting the sequence by the amount of cyclical shift; and transmitting the shifted sequence in a symbol corresponding to the symbol index.

### CROSS-REFERENCE TO RELATED APPLICATIONS

This application claims the benefit of U.S. Provisional Patent No. 62/319,286, filed Apr. 6, 2016. The content of the provisional application is hereby incorporated by reference in its entirety.

### FIELD

Certain aspects of the present disclosure generally relate to wireless communications and, more particularly, to techniques for generating synchronization signals for cell synchronization.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include Long Term Evolution (LTE) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

In some examples, a wireless multiple-access communication system may include a number of base stations, each simultaneously supporting communication for multiple communication devices, otherwise known as user equipment (UEs). In LTE or LTE-A network, a set of one or more base stations may define an e NodeB (eNB). In other examples (e.g., in a next generation or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more distributed units, in communication with a central unit, may define an access node (e.g., a new radio base station (NR BS), a new radio node-B (NR NB), a network node, 5G NB, eNB, etc.). A base station or DU may communicate with a set of UEs on downlink channels (e.g., for transmissions from a base station or to a UE) and uplink channels (e.g., for transmissions from a UE to a base station or distributed unit).

These multiple access technologies have been adopted in various telecommunication standards to provide a common protocol that enables different wireless devices to communicate on a municipal, national, regional, and even global level. An example of an emerging telecommunication standard is new radio (NR), for example, 5G radio access. NR is a set of enhancements to the LTE mobile standard promulgated by Third Generation Partnership Project (3GPP). It is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL) as well as support beamforming, multiple-input multiple-output (MIMO) antenna technology, and carrier aggregation.

In order for a UE to communicate with a base station in a cell (e.g., the coverage area of a base station), the UE needs to be synchronized with the timing of the cell. Accordingly, techniques described herein relate to generating synchronization signals to synchronize the UE with the timing of the cell.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network.

Certain aspects of the present disclosure provide a method for wireless communication. The method generally includes determining a symbol index for transmitting a sequence; determining an amount of cyclical shift in one of a frequency domain and a time domain to apply to the sequence, wherein the amount of cyclical shift in the frequency domain is based on the sequence and the symbol index; shifting the sequence by the amount of cyclical shift; and transmitting the shifted sequence in a symbol corresponding to the symbol index.

Certain aspects of the present disclosure provide a method for wireless communication. The method generally includes receiving a sequence from a base station; determining a symbol index where the sequence is received based on an amount of cyclical shift in one of a frequency domain and a time domain applied to the sequence, wherein the amount of cyclical shift is based on the sequence and the symbol index; and synchronizing timing with the base station based on the determined symbol index.

Certain aspects of the present disclosure provide a base station. The base station includes a memory and a processor couple to the memory. The processor is configured to determine a symbol index for transmitting a sequence; determine an amount of cyclical shift in one of a frequency domain and a time domain to apply to the sequence, wherein the amount of cyclical shift in the frequency domain is based on the sequence and the symbol index; shift the sequence by the amount of cyclical shift; and transmit the shifted sequence in a symbol corresponding to the symbol index.

Certain aspects of the present disclosure provide a user equipment. The user equipment includes a memory and a processor couple to the memory. The processor is configured to receive a sequence from a base station; determine a symbol index where the sequence is received based on an amount of cyclical shift in one of a frequency domain and a time domain applied to the sequence, wherein the amount of cyclical shift is based on the sequence and the symbol index; and synchronize timing with the base station based on the determined symbol index.

Certain aspects of the present disclosure provide a base station. The base station generally includes means for determining a symbol index for transmitting a sequence; means for determining an amount of cyclical shift in one of a frequency domain and a time domain to apply to the sequence, wherein the amount of cyclical shift is based on the sequence and the symbol index; means for shifting the sequence by the amount of cyclical shift; and means for transmitting the shifted sequence in a symbol corresponding to the symbol index.

Certain aspects of the present disclosure provide a user equipment. The user equipment generally includes means for receiving a sequence from a base station; means for determining a symbol index where the sequence is received based on an amount of cyclical shift in one of a frequency domain and a time domain applied to the sequence, wherein the amount of cyclical shift is based on the sequence and the symbol index; and means for synchronizing timing with the base station based on the determined symbol index.

Certain aspects of the present disclosure provide a computer readable storage medium storing instructions that when executed by at least one processor cause the at least one processor to perform a method. The method generally includes determining a symbol index for transmitting a sequence; determining an amount of cyclical shift in one of a frequency domain and a time domain to apply to the sequence, wherein the amount of cyclical shift in the frequency domain is based on the sequence and the symbol index; shifting the sequence by the amount of cyclical shift; and transmitting the shifted sequence in a symbol corresponding to the symbol index.

Certain aspects of the present disclosure provide a computer readable storage medium storing instructions that when executed by at least one processor cause the at least one processor to perform a method. The method generally includes receiving a sequence from a base station; determining a symbol index where the sequence is received based on an amount of cyclical shift in one of a frequency domain and a time domain applied to the sequence, wherein the amount of cyclical shift is based on the sequence and the symbol index; and synchronizing timing with the base station based on the determined symbol index.

Aspects generally include methods, apparatus, systems, computer readable mediums, and processing systems, as substantially described herein with reference to and as illustrated by the accompanying drawings.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram illustrating an example logical architecture of a distributed RAN, in accordance with certain aspects of the present disclosure.

FIG. 3 is a diagram illustrating an example physical architecture of a distributed RAN, in accordance with certain aspects of the present disclosure.

FIG. 4 is a block diagram conceptually illustrating a design of an example BS and user equipment (UE), in accordance with certain aspects of the present disclosure.

FIG. 5 is a diagram showing examples for implementing a communication protocol stack, in accordance with certain aspects of the present disclosure.

FIG. 6 illustrates an example of a DL-centric subframe, in accordance with certain aspects of the present disclosure.

FIG. 7 illustrates an example of an UL-centric subframe, in accordance with certain aspects of the present disclosure.

FIG. 8 illustrates example operations for generating and transmitting synchronization signals that may be performed by a base station, in accordance with certain aspects of the present disclosure.

FIG. 9 illustrates example operations for receiving synchronization signals and determining synchronization timing that may be performed by a user equipment, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for new radio (NR) (new radio access technology or 5G technology).

NR may support various wireless communication services, such as Enhanced mobile broadband (eMBB) targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra reliable low latency communications (URLLC). These services may include latency and reliability requirements. These services may also have different transmission time intervals (TTI) to meet respective quality of service (QoS) requirements. In addition, these services may co-exist in the same subframe.

According to aspects of the present disclosure, techniques are provided to generate synchronization signals for cell synchronization. In particular, in certain aspects, techniques are provided to select an extended synchronization signal (ESS) sequence from a plurality of ESS sequences and determine a cyclic shift to apply to the selected ESS sequence (in the frequency domain or the time domain) based on 1) the symbol index of the symbol in which the ESS sequence is transmitted; and 2) which of the plurality of ESS sequences is selected (e.g., based on certain parameters of the selected ESS sequence, such as length and/or root). For example, the cyclic shift applied may be selected so that the cyclical shift in a frequency domain may correspond to a particular shift in a time domain for the ESS sequence or vice versa.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication networks such as LTE, CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). NR is an emerging wireless communications technology under development in conjunction with the 5G Technology Forum (5GTF). 3GPP Long Term Evolution (LTE) and LTE-Advanced (LTE-A) are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

### Example Wireless Communications System

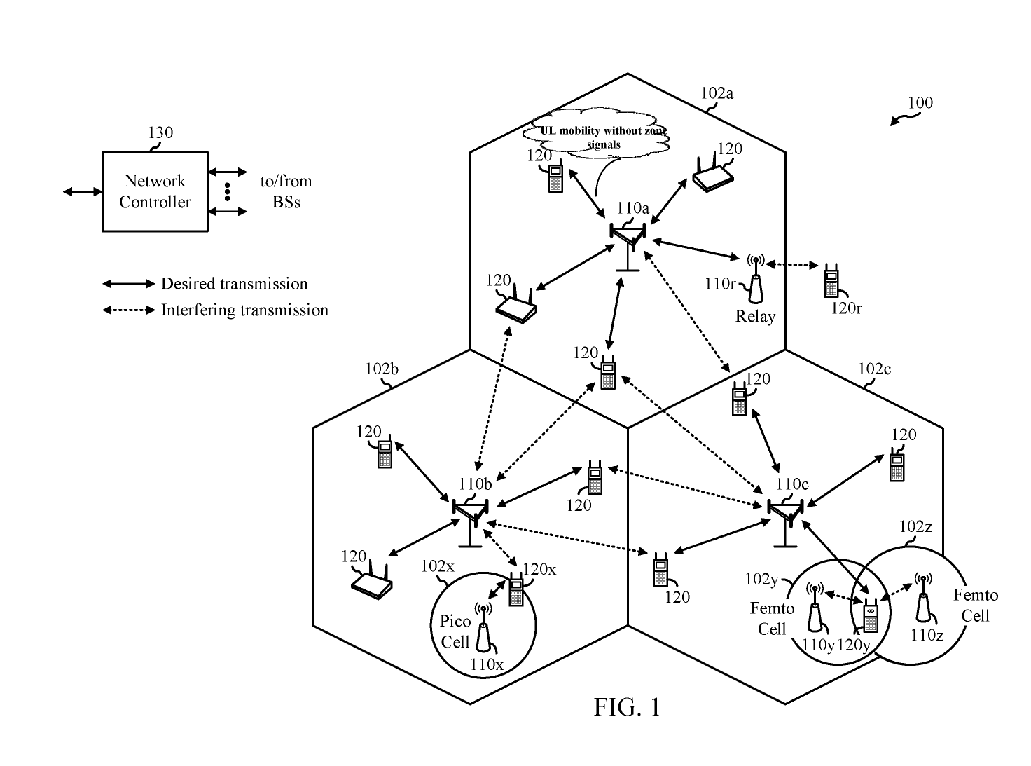

FIG. 1 illustrates an example wireless network 100, such as a new radio (NR) or 5G network, in which aspects of the present disclosure may be performed.

For example, a base station (BS) 110 selects an ESS sequence, applies a cyclic shift to the ESS sequence based on the selected sequence and a symbol index in which the selected ESS sequence is to be transmitted. Further, the BS transmits the ESS sequence in a symbol corresponding to the symbol index to a UE (e.g., UE 120).

As illustrated in FIG. 1, the wireless network 100 may include a number of base stations (BSs) 110 and other network entities. A BS may be a station that communicates with UEs. Each BS 110 may provide communication coverage for a particular geographic area. In 3GPP, the term “cell” can refer to a coverage area of a Node B and/or a Node B subsystem serving this coverage area, depending on the context in which the term is used. In NR systems, the term “cell” and eNB, Node B, 5G NB, AP, NR BS, NR BS, or TRP may be interchangeable. In some examples, a cell may not necessarily be stationary, and the geographic area of the cell may move according to the location of a mobile base station. In some examples, the base stations may be interconnected to one another and/or to one or more other base stations or network nodes (not shown) in the wireless network 100 through various types of backhaul interfaces such as a direct physical connection, a virtual network, or the like using any suitable transport network.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a frequency channel, etc. Each frequency may support a single RAT in a given geographic area in order to avoid interference between wireless networks of different RATs. In some cases, NR or 5G RAT networks may be deployed.

A BS may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BS for the femto cells 102y and 102z, respectively. A BS may support one or multiple (e.g., three) cells.

The wireless network 100 may also include relay stations. A relay station is a station that receives a transmission of data and/or other information from an upstream station (e.g., a BS or a UE) and sends a transmission of the data and/or other information to a downstream station (e.g., a UE or a BS). A relay station may also be a UE that relays transmissions for other UEs. In the example shown in FIG. 1, a relay station 110r may communicate with the BS 110a and a UE 120r in order to facilitate communication between the BS 110a and the UE 120r. A relay station may also be referred to as a relay BS, a relay, etc.

The wireless network 100 may be a heterogeneous network that includes BSs of different types, e.g., macro BS, pico BS, femto BS, relays, etc. These different types of BSs may have different transmit power levels, different coverage areas, and different impact on interference in the wireless network 100. For example, macro BS may have a high transmit power level (e.g., 20 Watts) whereas pico BS, femto BS, and relays may have a lower transmit power level (e.g., 1 Watt).

The wireless network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time. The techniques described herein may be used for both synchronous and asynchronous operation.

A network controller 130 may be coupled to a set of BSs and provide coordination and control for these BSs. The network controller 130 may communicate with the BSs 110 via a backhaul. The BSs 110 may also communicate with one another, e.g., directly or indirectly via wireless or wireline backhaul.

The UEs 120 (e.g., 120x, 120y, etc.) may be dispersed throughout the wireless network 100, and each UE may be stationary or mobile. A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered evolved or machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices.

In FIG. 1, a solid line with double arrows indicates desired transmissions between a UE and a serving BS, which is a BS designated to serve the UE on the downlink and/or uplink. A dashed line with double arrows indicates interfering transmissions between a UE and a BS.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a ‘resource block’) may be 12 subcarriers (or 180 kHz). Consequently, the nominal FFT size may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

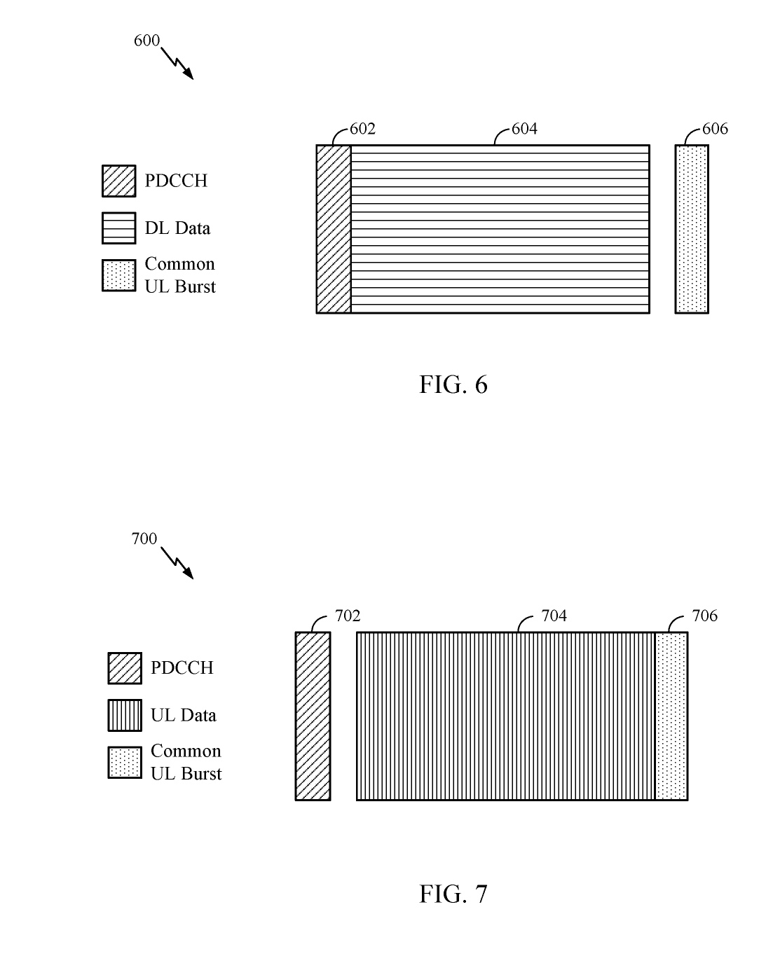

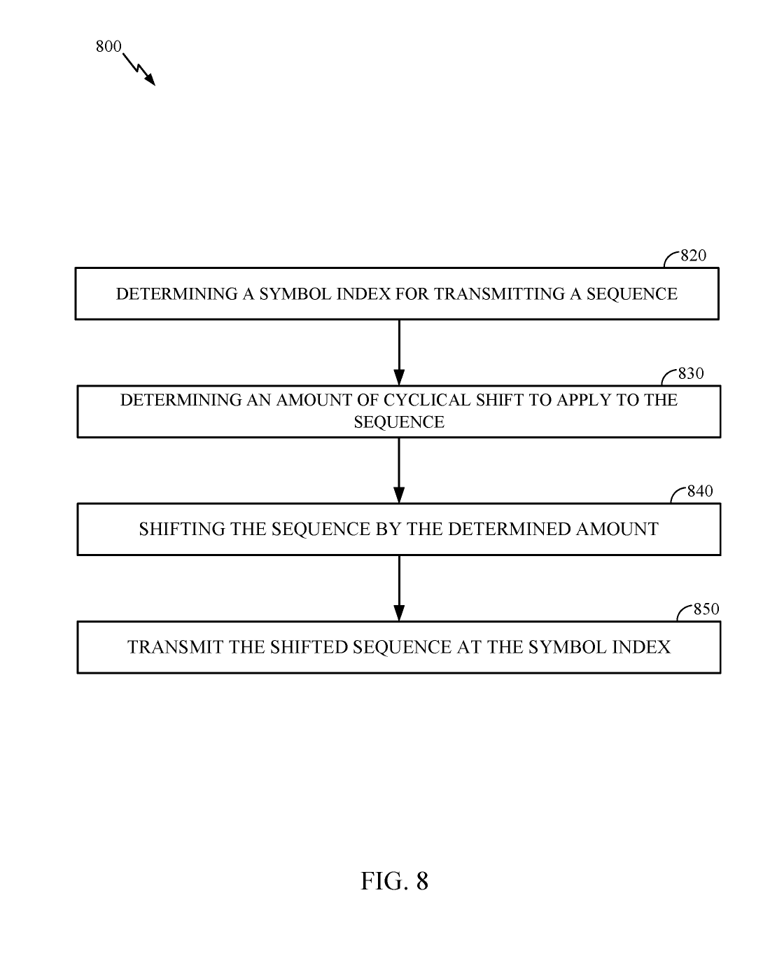

While aspects of the examples described herein may be associated with LTE technologies, aspects of the present disclosure may be applicable with other wireless communications systems, such as NR. NR may utilize OFDM with a CP on the uplink and downlink and include support for half-duplex operation using time division duplex (TDD). A single component carrier bandwidth of 100 MHz may be supported. NR resource blocks may span 12 sub-carriers with a sub-carrier bandwidth of 75 kHz over a 0.1 ms duration. Each radio frame may consist of 50 subframes with a length of 10 ms. Consequently, each subframe may have a length of 0.2 ms. Each subframe may indicate a link direction (i.e., DL or UL) for data transmission and the link direction for each subframe may be dynamically switched. Each subframe may include DL/UL data as well as DL/UL control data. Each subframe may include a number of symbols (e.g., indexed by symbol index) in time. UL and DL subframes for NR may be as described in more detail below with respect to FIGS. 6 and 7. Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells. Alternatively, NR may support a different air interface, other than an OFDM-based. NR networks may include entities such CUs and/or DUs.

In some examples, access to the air interface may be scheduled, wherein a scheduling entity (e.g., a base station) allocates resources for communication among some or all devices and equipment within its service area or cell. Within the present disclosure, as discussed further below, the scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. That is, in some examples, a UE may function as a scheduling entity, scheduling resources for one or more subordinate entities (e.g., one or more other UEs). In this example, the UE is functioning as a scheduling entity, and other UEs utilize resources scheduled by the UE for wireless communication. A UE may function as a scheduling entity in a peer-to-peer (P2P) network, and/or in a mesh network. In a mesh network example, UEs may optionally communicate directly with one another in addition to communicating with the scheduling entity.

Thus, in a wireless communication network with a scheduled access to time—frequency resources and having a cellular configuration, a P2P configuration, and a mesh configuration, a scheduling entity and one or more subordinate entities may communicate utilizing the scheduled resources.

As noted above, a RAN may include a CU and DUs. A NR BS (e.g., eNB, 5G Node B, Node B, transmission reception point (TRP), access point (AP)) may correspond to one or multiple BSs. NR cells can be configured as access cell (ACells) or data only cells (DCells). For example, the RAN (e.g., a central unit or distributed unit) can configure the cells. DCells may be cells used for carrier aggregation or dual connectivity, but not used for initial access, cell selection/reselection, or handover. In some cases DCells may not transmit synchronization signals—in some case cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

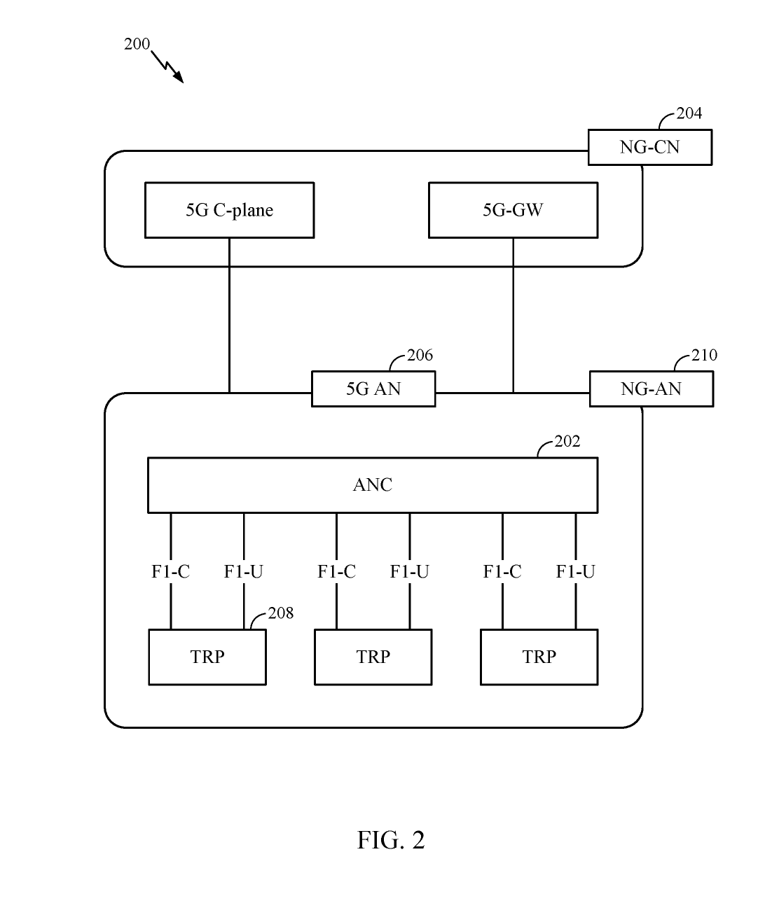

FIG. 2 illustrates an example logical architecture of a distributed radio access network (RAN) 200, which may be implemented in the wireless communication system illustrated in FIG. 1. A 5G access node 206 may include an access node controller (ANC) 202. The ANC may be a central unit (CU) of the distributed RAN 200. The backhaul interface to the next generation core network (NG-CN) 204 may terminate at the ANC. The backhaul interface to neighboring next generation access nodes (NG-ANs) may terminate at the ANC. The ANC may include one or more TRPs 208 (which may also be referred to as BSs, NR BSs, Node Bs, 5G NBs, APs, or some other term). As described above, a TRP may be used interchangeably with “cell.”

The TRPs 208 may be a DU. The TRPs may be connected to one ANC (ANC 202) or more than one ANC (not illustrated). For example, for RAN sharing, radio as a service (RaaS), and service specific AND deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture 200 may be used to illustrate fronthaul definition. The architecture may be defined that support fronthauling solutions across different deployment types. For example, the architecture may be based on transmit network capabilities (e.g., bandwidth, latency, and/or jitter).

The architecture may share features and/or components with LTE. According to aspects, the next generation AN (NG-AN) 210 may support dual connectivity with NR. The NG-AN may share a common fronthaul for LTE and NR.

The architecture may enable cooperation between and among TRPs 208. For example, cooperation may be preset within a TRP and/or across TRPs via the ANC 202. According to aspects, no inter-TRP interface may be needed/present.

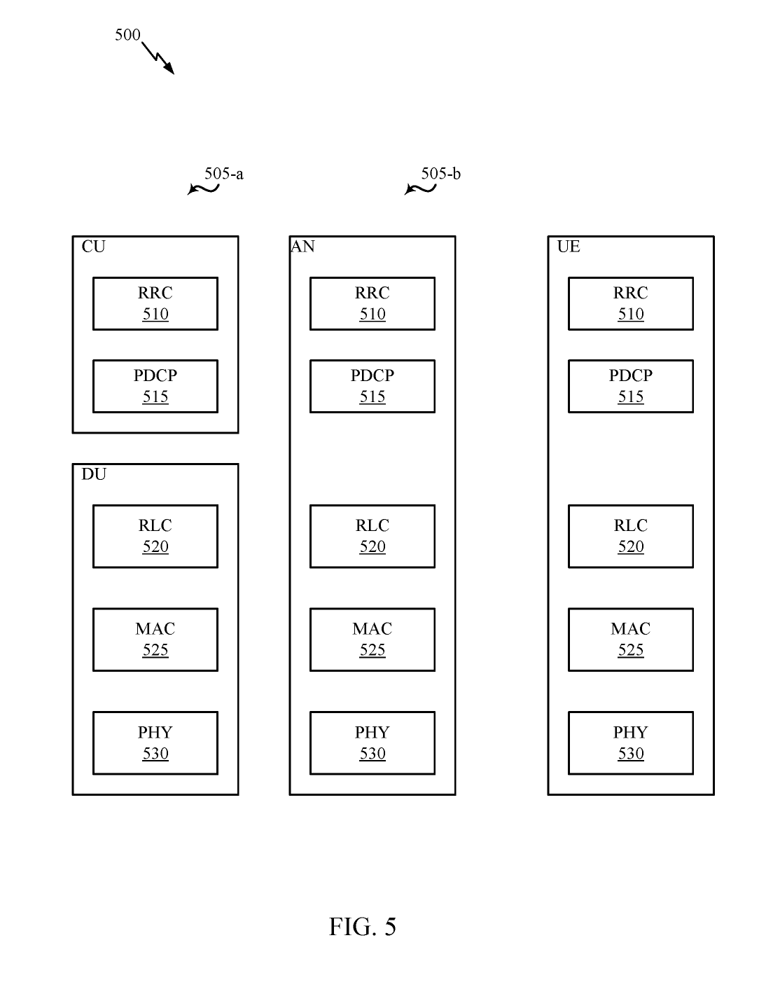

According to aspects, a dynamic configuration of split logical functions may be present within the architecture 200. As will be described in more detail with reference to FIG. 5, the Radio Resource Control (RRC) layer, Packet Data Convergence Protocol (PDCP) layer, Radio Link Control (RLC) layer, Medium Access Control (MAC) layer, and a Physical (PHY) layers may be adaptably placed at the DU or CU (e.g., TRP or ANC, respectively). According to certain aspects, a BS may include a central unit (CU) (e.g., ANC 202) and/or one or more distributed units (e.g., one or more TRPs 208).

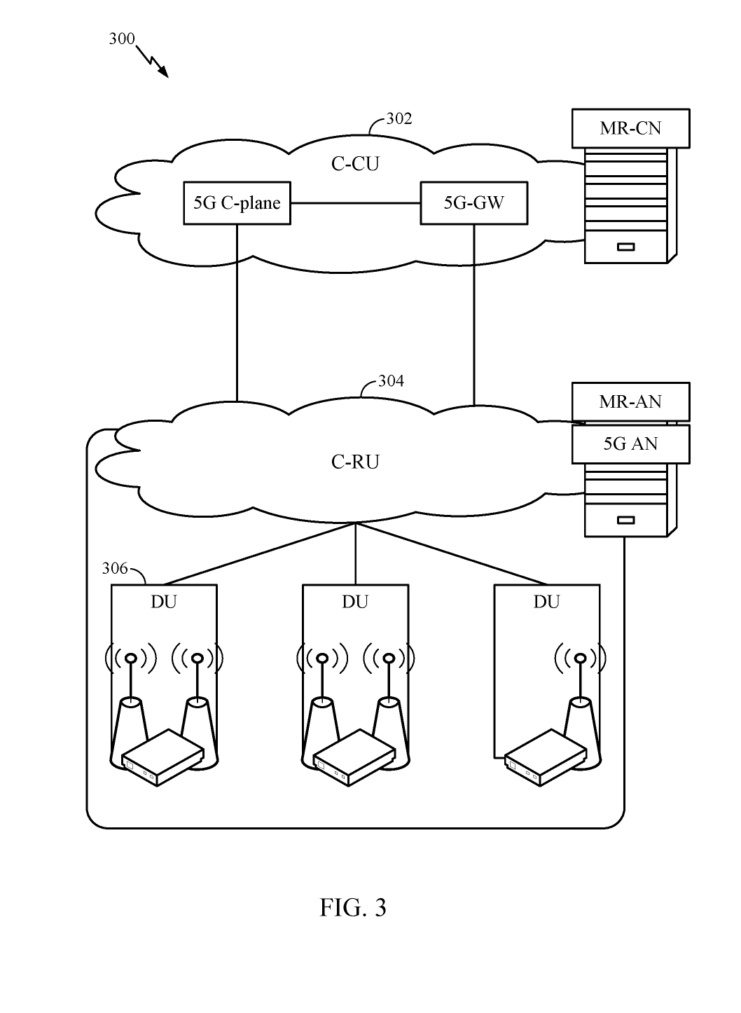

FIG. 3 illustrates an example physical architecture of a distributed RAN 300, according to aspects of the present disclosure. A centralized core network unit (C-CU) 302 may host core network functions. The C-CU may be centrally deployed. C-CU functionality may be offloaded (e.g., to advanced wireless services (AWS)), in an effort to handle peak capacity.

A centralized RAN unit (C-RU) 304 may host one or more ANC functions. Optionally, the C-RU may host core network functions locally. The C-RU may have distributed deployment. The C-RU may be closer to the network edge.

A DU 306 may host one or more TRPs (edge node (EN), an edge unit (EU), a radio head (RH), a smart radio head (SRH), or the like). The DU may be located at edges of the network with radio frequency (RF) functionality.

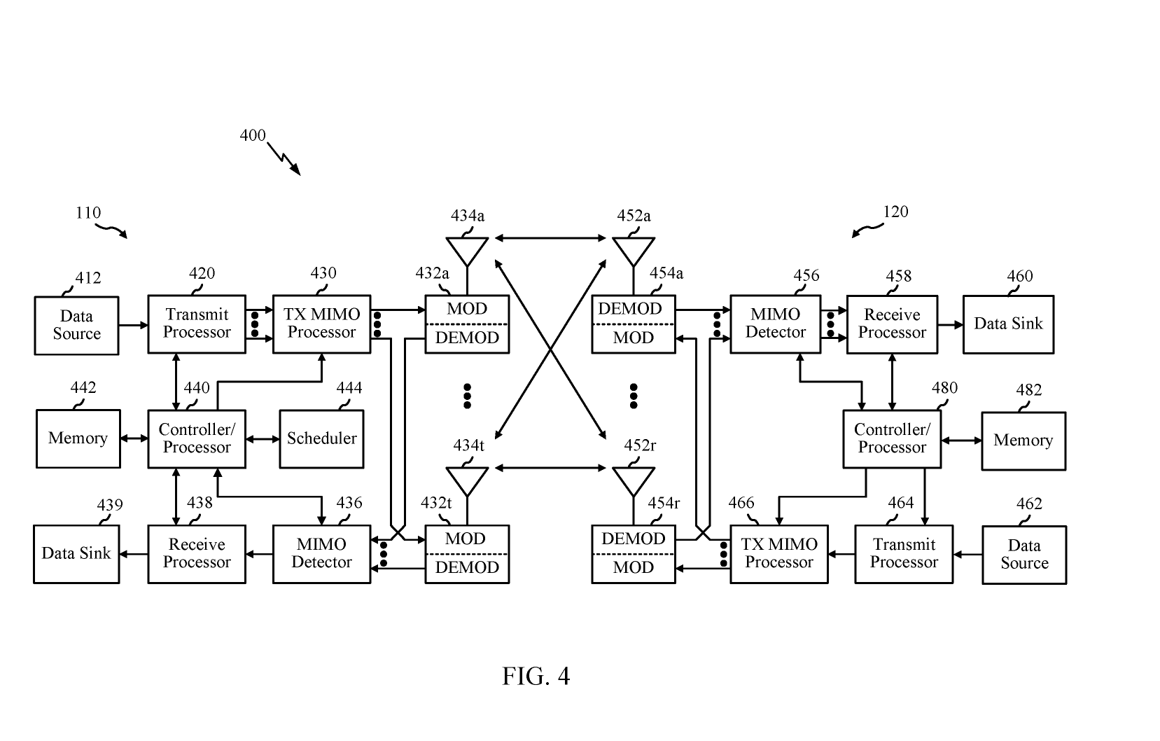

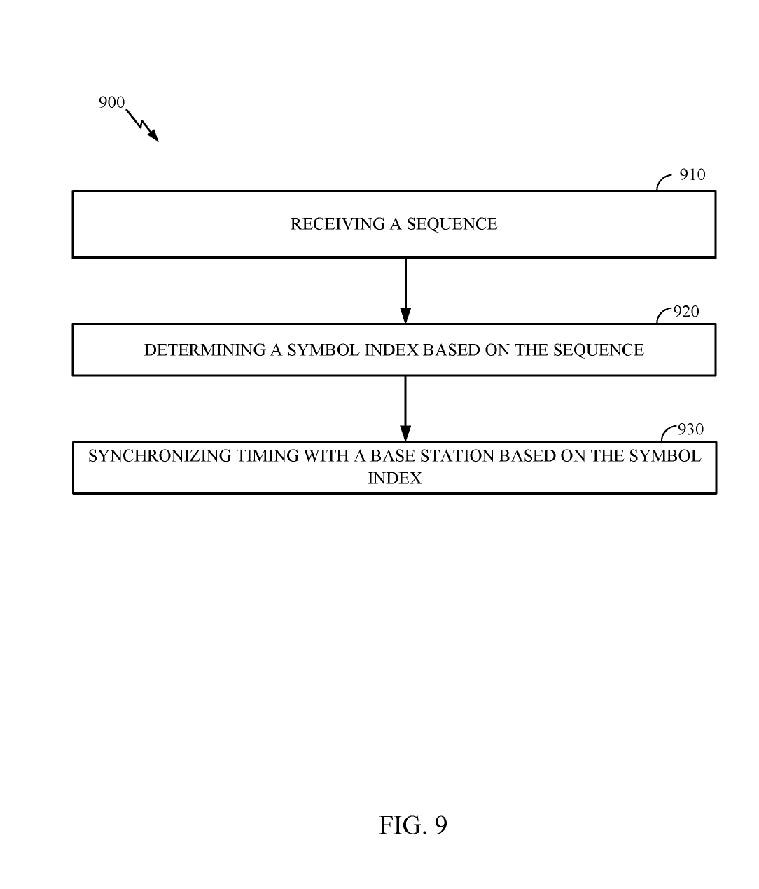

FIG. 4 illustrates example components of the BS 110 and UE 120 illustrated in FIG. 1, which may be used to implement aspects of the present disclosure. As described above, the BS may include a TRP. One or more components of the BS 110 and UE 120 may be used to practice aspects of the present disclosure. For example, antennas 452, Tx/Rx 222, processors 466, 458, 464, and/or controller/processor 480 of the UE 120 and/or antennas 434, processors 460, 420, 438, and/or controller/processor 440 of the BS 110 may be used to perform the operations described herein and illustrated with reference to FIG. 8 or 9.

FIG. 4 shows a block diagram of a design of a BS 110 and a UE 120, which may be one of the BSs and one of the UEs in FIG. 1. For a restricted association scenario, the base station 110 may be the macro BS 110c in FIG. 1, and the UE 120 may be the UE 120y. The base station 110 may also be a base station of some other type. The base station 110 may be equipped with antennas 434a through 434t, and the UE 120 may be equipped with antennas 452a through 452r.

At the base station 110, a transmit processor 420 may receive data from a data source 412 and control information from a controller/processor 440. The control information may be for the Physical Broadcast Channel (PBCH), Physical Control Format Indicator Channel (PCFICH), Physical Hybrid ARQ Indicator Channel (PHICH), Physical Downlink Control Channel (PDCCH), etc. The data may be for the Physical Downlink Shared Channel (PDSCH), etc. The processor 420 may process (e.g., encode and symbol map) the data and control information to obtain data symbols and control symbols, respectively. The processor 420 may also generate reference symbols, e.g., for the PSS, SSS, ESS, and cell-specific reference signal. A transmit (TX) multiple-input multiple-output (MIMO) processor 430 may perform spatial processing (e.g., precoding) on the data symbols, the control symbols, and/or the reference symbols, if applicable, and may provide output symbol streams to the modulators (MODs) 432a through 432t. Each modulator 432 may process a respective output symbol stream (e.g., for OFDM, etc.) to obtain an output sample stream. Each modulator 432 may further process (e.g., convert to analog, amplify, filter, and upconvert) the output sample stream to obtain a downlink signal. Downlink signals from modulators 432a through 432t may be transmitted via the antennas 434a through 434t, respectively.

At the UE 120, the antennas 452a through 452r may receive the downlink signals from the base station 110 and may provide received signals to the demodulators (DEMODs) 454a through 454r, respectively. Each demodulator 454 may condition (e.g., filter, amplify, downconvert, and digitize) a respective received signal to obtain input samples. Each demodulator 454 may further process the input samples (e.g., for OFDM, etc.) to obtain received symbols. A MIMO detector 456 may obtain received symbols from all the demodulators 454a through 454r, perform MIMO detection on the received symbols if applicable, and provide detected symbols. A receive processor 458 may process (e.g., demodulate, deinterleave, and decode) the detected symbols, provide decoded data for the UE 120 to a data sink 460, and provide decoded control information to a controller/processor 480.

On the uplink, at the UE 120, a transmit processor 464 may receive and process data (e.g., for the Physical Uplink Shared Channel (PUSCH)) from a data source 462 and control information (e.g., for the Physical Uplink Control Channel (PUCCH) from the controller/processor 480. The transmit processor 464 may also generate reference symbols for a reference signal. The symbols from the transmit processor 464 may be precoded by a TX MIMO processor 466 if applicable, further processed by the demodulators 454a through 454r (e.g., for SC-FDM, etc.), and transmitted to the base station 110. At the BS 110, the uplink signals from the UE 120 may be received by the antennas 434, processed by the modulators 432, detected by a MIMO detector 436 if applicable, and further processed by a receive processor 438 to obtain decoded data and control information sent by the UE 120. The receive processor 438 may provide the decoded data to a data sink 439 and the decoded control information to the controller/processor 440.

The controllers/processors 440 and 480 may direct the operation at the base station 110 and the UE 120, respectively. The processor 440 and/or other processors and modules at the base station 110 may perform or direct processes for the techniques described herein, such as described with respect to FIG. 8. The processor 480 and/or other processors and modules at the UE 120 may perform or direct processes for the techniques described herein, such as described with respect to FIG. 9. The memories 442 and 482 may store data and program codes for the BS 110 and the UE 120, respectively. A scheduler 444 may schedule UEs for data transmission on the downlink and/or uplink.

FIG. 5 illustrates a diagram 500 showing examples for implementing a communications protocol stack, according to aspects of the present disclosure. The illustrated communications protocol stacks may be implemented by devices operating in a in a 5G system (e.g., a system that supports uplink-based mobility). Diagram 500 illustrates a communications protocol stack including a Radio Resource Control (RRC) layer 510, a Packet Data Convergence Protocol (PDCP) layer 515, a Radio Link Control (RLC) layer 520, a Medium Access Control (MAC) layer 525, and a Physical (PHY) layer 530. In various examples the layers of a protocol stack may be implemented as separate modules of software, portions of a processor or ASIC, portions of non-collocated devices connected by a communications link, or various combinations thereof. Collocated and non-collocated implementations may be used, for example, in a protocol stack for a network access device (e.g., ANs, CUs, and/or DUs) or a UE.

A first option 505-a shows a split implementation of a protocol stack, in which implementation of the protocol stack is split between a centralized network access device (e.g., an ANC 202 in FIG. 2) and distributed network access device (e.g., DU 208 in FIG. 2). In the first option 505-a, an RRC layer 510 and a PDCP layer 515 may be implemented by the central unit, and an RLC layer 520, a MAC layer 525, and a PHY layer 530 may be implemented by the DU. In various examples the CU and the DU may be collocated or non-collocated. The first option 505-a may be useful in a macro cell, micro cell, or pico cell deployment.

A second option 505-b shows a unified implementation of a protocol stack, in which the protocol stack is implemented in a single network access device (e.g., access node (AN), new radio base station (NR BS), a new radio Node-B (NR NB), a network node (NN), or the like.). In the second option, the RRC layer 510, the PDCP layer 515, the RLC layer 520, the MAC layer 525, and the PHY layer 530 may each be implemented by the AN. The second option 505-b may be useful in a femto cell deployment.

Regardless of whether a network access device implements part or all of a protocol stack, a UE may implement an entire protocol stack (e.g., the RRC layer 510, the PDCP layer 515, the RLC layer 520, the MAC layer 525, and the PHY layer 530).

FIG. 6 is a diagram 600 showing an example of a DL-centric subframe. The DL-centric subframe may include a control portion 602. The control portion 602 may exist in the initial or beginning portion of the DL-centric subframe. The control portion 602 may include various scheduling information and/or control information corresponding to various portions of the DL-centric subframe. In some configurations, the control portion 602 may be a physical DL control channel (PDCCH), as indicated in FIG. 6. The DL-centric subframe may also include a DL data portion 604. The DL data portion 604 may sometimes be referred to as the payload of the DL-centric subframe. The DL data portion 604 may include the communication resources utilized to communicate DL data from the scheduling entity (e.g., UE or BS) to the subordinate entity (e.g., UE). In some configurations, the DL data portion 604 may be a physical DL shared channel (PDSCH).

The DL-centric subframe may also include a common UL portion 606. The common UL portion 606 may sometimes be referred to as an UL burst, a common UL burst, and/or various other suitable terms. The common UL portion 606 may include feedback information corresponding to various other portions of the DL-centric subframe. For example, the common UL portion 606 may include feedback information corresponding to the control portion 602. Non-limiting examples of feedback information may include an ACK signal, a NACK signal, a HARQ indicator, and/or various other suitable types of information. The common UL portion 606 may include additional or alternative information, such as information pertaining to random access channel (RACH) procedures, scheduling requests (SRs), and various other suitable types of information. As illustrated in FIG. 6, the end of the DL data portion 604 may be separated in time from the beginning of the common UL portion 606. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric subframe and alternative structures having similar features may exist without necessarily deviating from the aspects described herein.

FIG. 7 is a diagram 700 showing an example of an UL-centric subframe. The UL -centric subframe may include a control portion 702. The control portion 702 may exist in the initial or beginning portion of the UL-centric subframe. The control portion 702 in FIG. 7 may be similar to the control portion described above with reference to FIG. 6. The UL-centric subframe may also include an UL data portion 704. The UL data portion 704 may sometimes be referred to as the payload of the UL-centric subframe. The UL portion may refer to the communication resources utilized to communicate UL data from the subordinate entity (e.g., UE) to the scheduling entity (e.g., UE or BS). In some configurations, the control portion 702 may be a physical DL control channel (PDCCH).

As illustrated in FIG. 7, the end of the control portion 702 may be separated in time from the beginning of the UL data portion 704. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric subframe may also include a common UL portion 706. The common UL portion 706 in FIG. 7 may be similar to the common UL portion 706 described above with reference to FIG. 7. The common UL portion 706 may additional or alternative include information pertaining to channel quality indicator (CQI), sounding reference signals (SRSs), and various other suitable types of information. One of ordinary skill in the art will understand that the foregoing is merely one example of an UL-centric subframe and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

A UE may operate in various radio resource configurations, including a configuration associated with transmitting pilots using a dedicated set of resources (e.g., a radio resource control (RRC) dedicated state, etc.) or a configuration associated with transmitting pilots using a common set of resources (e.g., an RRC common state, etc.). When operating in the RRC dedicated state, the UE may select a dedicated set of resources for transmitting a pilot signal to a network. When operating in the RRC common state, the UE may select a common set of resources for transmitting a pilot signal to the network. In either case, a pilot signal transmitted by the UE may be received by one or more network access devices, such as an AN, or a DU, or portions thereof. Each receiving network access device may be configured to receive and measure pilot signals transmitted on the common set of resources, and also receive and measure pilot signals transmitted on dedicated sets of resources allocated to the UEs for which the network access device is a member of a monitoring set of network access devices for the UE. One or more of the receiving network access devices, or a CU to which receiving network access device(s) transmit the measurements of the pilot signals, may use the measurements to identify serving cells for the UEs, or to initiate a change of serving cell for one or more of the UEs.

### Example Techniques for Generating Synchronization Signals

As discussed above, a BS may generate and send a PSS and SSS for each cell assigned to the BS. A UE in the cell may receive these synchronization signals for cell detection and acquisition, meaning the UE may use these synchronization signals to synchronize with a timing of the BS. For example, with respect to LTE the PSS and SSS are always transmitted in particular symbol periods (e.g., 6 and 5, respectively) of particular subframes (e.g., 0 and 5) of each frame. The UE receiving such a PSS and SSS can synchronize to the symbol index level (e.g., the UE can determine when the subframe starts) in such a system with the BS based on the received PSS and SSS.

In certain aspects, the particular sequences which are transmitted for the PSS and SSS in a given cell are used to indicate the physical layer cell identity to the UE. The P-SCH signal is a Zadoff-Chu sequence. It is also referred to as Chu sequence or Zadoff-Chu (ZC) sequence. Three sequences are generated from three roots: 25, 29 and 34. Each sequence provides a unique cell identity within the cell identity group. The sequence is generated in two parts, with n=0, 1 . . . 30 and n=31, 32, . . . 61. The Zadoff-Chu (ZC) sequence, is a complex-valued mathematical sequence. It gives rise to an electromagnetic signal of constant amplitude when it is applied to radio signals, whereby cyclically shifted versions of the sequence (e.g., in the frequency domain) imposed on a signal result in zero correlation with one another at the receiver. The “root sequence” is a generated Zadoff-Chu sequence that has not been shifted. These sequences exhibit a property that cyclically shifted versions of itself are orthogonal to one another, provided that each cyclic shift, when viewed within the time domain of the signal, is greater than the combined multi-path delay-spread and propagation delay of that signal between the transmitter and receiver.

In certain aspects, as described herein, unlike in the LTE system described above, PSS and SSS are not transmitted by the BS 110 in particular symbol periods (e.g., 6 and 5, respectively) of particular subframes (e.g., 0 and 5) of each frame. Rather, in certain aspects, the PSS and SSS may be transmitted by the BS 110 in a plurality of symbols (e.g., of the 14 symbols) (e.g., all of the symbols) of one or more particular subframes (e.g., 0 and 5) (also referred to as “synchronization subframes”). In certain aspects, the PSS and SSS are transmitted by the BS 110 in the same symbol using FDM. The PSS and SSS may be transmitted utilizing beamforming, with each symbol of the plurality of symbols of the subframe being used for transmission in different directions. Accordingly, since the PSS and SSS are transmitted in the plurality of symbols in different directions, the UE 120 may only be able to determine the subframe timing based on the particular subframes the PSS and SSS are transmitted in by the BS 110 and not the symbol index timing.

In certain aspects, the BS 110 may also generate and send an extended synchronization signal (ESS) along with the PSS and the SSS for each cell assigned to the BS 110. A UE 120 in the cell may receive the ESS in addition to the PSS and the SSS for cell detection and acquisition. The ESS may be used to further convey symbol index information to the UE 120, so that the UE 120 can synchronize with the BS 110 at the symbol index level. The ESS, however, may be changed from symbol to symbol, so that the ESS in each of the symbols is distinguishable. Accordingly, the ESS can convey the symbol index it is transmitted in, since the ESS at each symbol index is distinguishable. By utilizing the symbol index information, the UE 120 can determine when the subframe itself starts (e.g., the time corresponding to symbol index 0). In certain aspects, a specific root sequence, e.g., ZC sequence with a specific root, is used for the ESS. Further, in some aspects, the ESS may be selected by BS 110 based on cell-specific information (such as cell ID PCI) may also be used by the UE 120 to determine or confirm the cell-specific information.

In certain aspects, the BS 110 may generate a particular sequence (e.g., ZC sequence) (referred to as an “ESS sequence”) for a synchronization subframe. The BS 110 may, for example, select a particular sequence from a plurality of sequences, or there may be a specific sequence used by the BS 110, based on known techniques for signaling information to the UE. The ESS transmitted in each symbol of the synchronization subframe may comprise the particular ESS sequence cyclically shifted by the BS 110 in the frequency domain or time domain by a different amount for each of the symbols. For example, where there are 14 symbols for the synchronization subframe, the ESS sequence may be shifted by 14 different amounts, making 14 different shifted versions of the ESS sequence, each shifted version being transmitted and corresponding to a different symbol of the synchronization subframe.

It should be noted that when referring to shifts in the frequency domain and the time domain, herein, the amount of shift corresponds to a number of samples in each domain. In particular, the frequency domain version of a signal may correspond to a Fourier transform (e.g., discrete Fourier transform (DFT)) of a time domain version of the signal, and the time domain version of the signal may correspond to an inverse Fourier transform (e.g., inverse discrete Fourier transform (IDFT)) of a frequency domain version of the signal. The frequency domain version and time domain version of the signal may have the same number of values (“samples”) and a shift in a given domain may refer to an amount of samples shifted in that domain. One of skill in the art will understand those samples may refer to different units (e.g., subcarriers, ms, symbols, etc.) in each of the domains.

Further, it should be noted that though in the below disclosure, discussion is made with respect to the BS shifting the ESS sequence in the frequency domain to achieve the desired shift in the frequency domain and the time domain, one of ordinary skill in the art will understand that the BS may make a corresponding shift to the ESS sequence in the time domain instead to achieve the desired shift in each of the frequency domain and the time domain.

In certain aspects, the ESS may comprise a ZC sequence of the same root as the PSS transmitted by the BS 110. Accordingly, the shift in correlation peak due to carrier frequency offset (CFO) of the ESS and PSS may be substantially identical. Therefore, the symbol index or any information coded in the location of the correlation peak of the ESS can be robustly detected even in the presence of CFO by the UE 120.

Further, in certain aspects, the BS 110 may transmit the PSS and the ESS in the same symbol (e.g., OFDM symbol) using FDM. In certain such aspects, the PSS may comprise a ZC sequence, and the ESS may be the conjugate of the PSS. Accordingly, the shift in correlation peaks of the PSS and ESS may be in the opposite direction and can therefore be used to estimate CFO. Further, the large-scale shift in the correlation peak of the ESS may convey the symbol index. The small-scale shift within 1/N (where N is the total number of symbols in the subframe) of the symbol duration, along with the shift in the opposite direction in the PSS correlation peak, may convey the CFO.

In certain aspects, the BS 110 selects an ESS sequence based at least in part on cell-specific information, such as cell ID of the BS 110. For example, the BS 110 may scramble the ESS with a cell-specific (or virtual cell-specific) scrambling sequence and transmit the scrambled sequence. Accordingly, since the ESS includes cell-specific information, it can reduce ambiguity with respect to ESS received from neighboring cells by a UE 120. This may be useful in asynchronous or quasi-synchronous deployment. This may also be useful in synchronous networks where interference from other cells may cause the wrong symbol index hypothesis to pass, such as due to propagation delay.

In certain aspects, two or more neighboring BSs 110, or even all the BSs 110 in the entire network transmit the same ESS. Accordingly, the ESS is decoupled from a single cell and may be transmitted as a single frequency network (SFN) transmission for multiple (or all) cells. This may be useful in a synchronized network deployment, where neighboring BSs 110 announce the same symbol index using the same signal, thus possibly enhancing detection.

In certain aspects, as discussed above, the ESS transmitted in each symbol of the synchronization subframe may comprise the ESS sequence (e.g., a ZC sequence) cyclically shifted in the frequency domain or time domain by a different amount for each of the symbols. In certain aspects, the ESS sequence may be successively cyclically shifted by the same amount (e.g., 4) in the frequency domain for each successive symbol index. Accordingly, the symbol at index 0 may be shifted by 0, the symbol at index 1 shifted by 4, the symbol at index 2 shifted by 8, and so on. In such aspects, however, it should be noted that a shift in the frequency domain of a given size may not always correspond to the same size shift of symbols in the time domain, since a shift in the time domain may be based on the amount of shift in the frequency domain and the sequence being shifted. For example, a cyclic shift of D in the frequency domain may correspond to a cyclic shift of T in the time domain, where the time domain shift depends on the root of the sequence. Therefore, different sequences may shift by different amount in time domain for the same shift in frequency.

Accordingly, utilizing the same shift amount in frequency for the ESS sequence for each of the successive symbols may result in different shifts in the time domain for the ESS between each symbol. In such aspects, in some symbols, the ESS may be shifted more in the time domain, and in some symbols, the ESS may be shifted less in the time domain.

In certain aspects, it may be desirable to have the ESS in each adjacent symbol spaced apart as much as possible in the time domain from each other. In the aspects described where the same cyclical shift amount is applied to the ESS sequence in the frequency domain for successive symbols, this may not be achieved, since certain symbols may be spaced more closely than others. Accordingly, in certain aspects, the techniques described herein relate to the BS 110 determining the amount of cyclical shift to apply to the ESS sequence for successive symbols based on the symbol index and the ESS sequence itself (e.g., based on certain parameters of the ESS sequence, such as length and/or root).

In certain aspects, the amount of cyclical shift applied to the ESS sequence in the frequency domain for successive symbols is selected so as to have a particular shift in the time domain for the ESS transmitted in each symbol (or vice versa). For example, in certain aspects, the amount of cyclical shift applied in the frequency domain for each symbol may be selected so that adjacent symbols of adjacent symbol indexes are at least separated by a minimum amount in the time domain (or vice versa). In certain aspects, the minimum amount of separation in the time domain may be equal to the floor value of the length of the ESS sequence divided by the number of symbol indexes (e.g., floor((sequence length)/(number of symbol indexes)). Accordingly, the amount of separation in the time domain may be approximately equal to an average possible separation in the time domain based on the symbol length and number of symbol indexes. Further, in certain aspects, the amount of cyclical shift applied in the frequency domain for each symbol may be selected so that there is a minimum separation in the frequency domain (e.g., 2).

For example, (Δ₁, τ₁) may refer to the frequency domain shift and the corresponding time domain shift used by the BS 110 in symbol index 1 for the ESS sequence, and (Δ₂, τ₂) may refer to symbol index 2. In certain aspects, the BS 110 may try and select |Δ₁−Δ₂| to be at least the minimum separation in the frequency domain and |τ₁−τ₂| to be at least the minimum separation in the time domain. Accordingly, a UE 120 receiving the ESS in each of symbol index 1 and 2 can easily tell the two ESSs apart. In certain aspects, CFO effects distort Δ₁& Δ₂ whereas timing errors (e.g. due to propagation) distort τ₁ & τ₂ for the UE. In some aspects, timing ambiguity is more likely, and vice versa.

Therefore, in order to ensure adequate separation in the time domain (e.g., |τ₁−τ₂|>4) the cyclic shifts of ESS in frequency domain may depend on the root of the ESS sequence.

In certain aspects, the amount of shift to apply in the frequency domain or time domain for a given ESS sequence and a given symbol index is pre-determined and stored (e.g., as a lookup table, mapping, etc.) at the BS 110 and UE 120. The BS 110 may utilize the information about the symbol index to transmit the ESS sequence and the ESS sequence used for transmission to, for example, index the stored information to determine the amount of shift to apply in the frequency domain or time domain. The UE 120 may utilize the information to determine on which symbol index an ESS sequence is received. In certain aspects, the stored information is indicative of a different mapping (e.g., table) of symbol indexes to frequency domain shifts or time domain shifts for each different ESS sequence (e.g., different length and/or root of ESS sequence). In certain aspects, sequences that are conjugates may utilize the same mapping.

In certain aspects, the following equations may be used to derive the amount of shift to apply in the frequency domain or time domain for a given ESS sequence based on information about the ESS sequence in order to obtain a particular amount of shift in the frequency domain and the time domain for the ESS sequence:

τ=mod(Δ×u, L_{ZC});

Δ=mod(τ×u′, L_{ZC});

mod(u′×u, L_{ZC})=1

Where,

Δ is the amount of shift in the frequency domain,

τ is the amount of shift if the time domain,

u is the root of the ESS sequence (e.g., ZC sequence), and

L_{ZC} is the length of the base ZC.

Table 1 below illustrates an example mapping of an amount shift in the frequency domain for each of 14 different cyclically shifted ESS sequences in the frequency domain to the corresponding amount of shift in the time domain. The table may correspond to an ESS sequence of length 63 and root u=25. Accordingly, each row corresponds to a different symbol index (i.e., 0-13 going down). As shown, the shifts in the time domain are at least 4 apart, while shifts in the frequency domain are at least 3 apart. The Table 1 may therefore correspond to a portion of the information stored at the BS for determining an amount to shift an ESS sequence of length 63 and root u=25, for each symbol index. The BS may accordingly store information corresponding to mappings for other ESS sequences, as well.

TABLE 1

| Symbol Index | Frequency domain cyclic shift, Δ | Time-domain shift, τ |
|---|---|---|
| 0 | 0 | 0 |
| 1 | 9 | 36 |
| 2 | 13 | 10 |
| 3 | 16 | 22 |
| 4 | 20 | 59 |
| 5 | 29 | 32 |
| 6 | 32 | 44 |
| 7 | 36 | 18 |
| 8 | 40 | 55 |
| 9 | 43 | 4 |
| 10 | 49 | 28 |
| 11 | 52 | 40 |
| 12 | 56 | 14 |
| 13 | 60 | 51 |

For example, Table 2 illustrates an example mapping for an ESS sequence of length 63 and root u=34. Further, Table 3 illustrates an example mapping for an ESS sequence of length 63 and root u=29. As can be seen, the amount of shift in the frequency domain corresponding to a particular amount of shift in the time domain for each of the ESS sequences discussed with respect to tables 1-3 is different. Accordingly, as discussed, in certain aspects the amount of shift in the frequency domain for an ESS sequence is based on the ESS sequence (e.g., the length and/or root of the ESS sequence) and the symbol index for transmitting the ESS sequence.

TABLE 2

| Symbol Index | Frequency domain cyclic shift, Δ | Time-domain shift, τ |
|---|---|---|
| 0 | 0 | 0 |
| 1 | 4 | 10 |
| 2 | 8 | 20 |
| 3 | 11 | 59 |
| 4 | 15 | 6 |
| 5 | 19 | 16 |
| 6 | 22 | 55 |
| 7 | 27 | 36 |
| 8 | 33 | 51 |
| 9 | 38 | 32 |
| 10 | 44 | 47 |
| 11 | 49 | 28 |
| 12 | 55 | 43 |
| 13 | 60 | 24 |

TABLE 3

| Symbol Index | Frequency domain cyclic shift, Δ | Time-domain shift, τ |
|---|---|---|
| 0 | 0 | 0 |
| 1 | 4 | 53 |
| 2 | 8 | 43 |
| 3 | 11 | 4 |
| 4 | 15 | 57 |
| 5 | 19 | 47 |
| 6 | 22 | 8 |
| 7 | 27 | 27 |
| 8 | 33 | 12 |
| 9 | 38 | 31 |
| 10 | 44 | 16 |
| 11 | 49 | 35 |
| 12 | 55 | 20 |
| 13 | 60 | 39 |

With respect to the examples of Tables 1-3, both the amount of shift in the frequency domain and the amount of shift in the time domain are shown as different for the different sequences. However, in certain aspects, for certain ESS sequences, it is possible to have an equal amount of shift between symbols in the time domain for each ESS sequence, but a different amount of shift in the frequency domain for different ESS sequences. For example, as shown below, Table 4 corresponds to an ESS sequence of length 63 and root u=25; Table 5 corresponds to an ESS sequence of length 63 and root u=34; and Table 6 corresponds to an ESS sequence of length 63 and root u=29.

TABLE 4

| Symbol Index | Frequency domain cyclic shift, Δ | Time-domain shift, τ |
|---|---|---|
| 0 | 0 | 0 |
| 1 | 43 | 4 |
| 2 | 13 | 10 |
| 3 | 56 | 14 |
| 4 | 26 | 20 |
| 5 | 6 | 24 |
| 6 | 49 | 28 |
| 7 | 29 | 32 |
| 8 | 9 | 36 |
| 9 | 52 | 40 |
| 10 | 17 | 47 |
| 11 | 60 | 51 |
| 12 | 40 | 55 |
| 13 | 20 | 59 |

TABLE 5

| Symbol Index | Frequency domain cyclic shift, Δ | Time-domain shift, τ |
|---|---|---|
| 0 | 0 | 0 |
| 1 | 52 | 4 |
| 2 | 4 | 10 |
| 3 | 56 | 14 |
| 4 | 8 | 20 |
| 5 | 60 | 24 |
| 6 | 49 | 28 |
| 7 | 38 | 32 |
| 8 | 27 | 36 |
| 9 | 16 | 40 |
| 10 | 44 | 47 |
| 11 | 33 | 51 |
| 12 | 22 | 55 |
| 13 | 11 | 59 |

TABLE 6

| Symbol Index | Frequency domain cyclic shift, Δ | Time-domain shift, τ |
|---|---|---|
| 0 | 0 | 0 |
| 1 | 11 | 4 |
| 2 | 59 | 10 |
| 3 | 7 | 14 |
| 4 | 55 | 20 |
| 5 | 3 | 24 |
| 6 | 14 | 28 |
| 7 | 25 | 32 |
| 8 | 36 | 36 |
| 9 | 47 | 40 |
| 10 | 19 | 47 |
| 11 | 30 | 51 |
| 12 | 41 | 55 |
| 13 | 52 | 59 |

Table 7 below is yet another example of the frequency domain shift to be applied to different ESS sequences of length 63 and of roots u=25, 29, and 35. As shown, the shift in the time domain between symbols in table 7 is at least 4 samples, and the shift in the frequency domain between symbols is at least 2 samples.

TABLE 7

| | | Frequency domain cyclic shift, Δ | | |
|---|---|---|---|---|
| Symbol Index | Time-domain shift, τ | U = 25 | U = 29 | U = 34 |
| 0 | 0 | 0 | 0 | 0 |
| 1 | 5 | 38 | 61 | 2 |
| 2 | 9 | 18 | 9 | 54 |
| 3 | 13 | 61 | 20 | 43 |
| 4 | 17 | 41 | 31 | 32 |
| 5 | 21 | 21 | 42 | 21 |
| 6 | 26 | 59 | 40 | 23 |
| 7 | 31 | 34 | 38 | 25 |
| 8 | 35 | 14 | 49 | 14 |
| 9 | 40 | 52 | 47 | 16 |
| 10 | 44 | 32 | 58 | 5 |
| 11 | 49 | 7 | 56 | 7 |
| 12 | 54 | 45 | 54 | 9 |
| 13 | 58 | 25 | 2 | 61 |

FIG. 8 illustrates example operations 800 for generating and transmitting synchronization signals that may be performed by a base station, in accordance with certain aspects of the present disclosure. 8At 820, the BS 110 determines a symbol index for transmitting an ESS sequence (e.g., ZC sequence). For example, the BS 110 determines which symbol index is being used for transmission of the ESS sequence.

At 830, the BS 110 determines an amount of cyclical shift in a frequency domain or time domain to apply to the ESS sequence, wherein the amount of cyclical shift is based on the ESS sequence (e.g., root and/or length of the ESS sequence) and the symbol index. For example, the BS 110 uses the mapping of ESS sequence parameters and the symbol index to transmit the ESS sequence on to determine the shift amount in the frequency domain or time domain.

At 840, the BS 110 shifts the sequence by the determined shift amount, and at 850 transmits the shifted sequence on the symbol corresponding to the symbol index to the UE 120.

FIG. 9 illustrates example operations 900 for receiving synchronization signals and determining synchronization timing that may be performed by a user equipment, in accordance with certain aspects of the present disclosure.

At 910, the UE 120 receives an ESS sequence from a BS 110. At 920, the UE 120 determines a symbol index the ESS sequence was received on. For example, as discussed herein, the shift applied to the ESS sequence in the frequency domain or time domain, and the length and root of the ESS sequence may be determined by the UE 120 and the corresponding symbol index determined (such as using a lookup table, etc.).

At 930, the UE 120 utilizes the symbol index to synchronize timing with the BS 110.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

For example, means for transmitting and/or means for receiving may comprise one or more of a transmit processor 420, a TX MIMO processor 430, a receive processor 438, or antenna(s) 434 of the base station 110 and/or the transmit processor 464, a TX MIMO processor 466, a receive processor 458, or antenna(s) 452 of the user equipment 120. Additionally, means for selecting, means for determining, means for synchronizing, and/or means for shifting may comprise one or more processors, such as the controller/processor 440 of the base station 110 and/or the controller/processor 480 of the user equipment 120.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for perform the operations described herein and illustrated in FIG. 8 or 9.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method of wireless communication, comprising:
determining a symbol index for transmitting a sequence;
determining an amount of cyclical shift in one of a frequency domain and a time domain to apply to the sequence, wherein the amount of cyclical shift is based on the sequence and the symbol index;
shifting the sequence by the amount of cyclical shift; and
transmitting the shifted sequence in a symbol corresponding to the symbol index.

2. The method of claim 1, wherein the sequence comprises a Zadoff-Chu sequence.

3. The method of claim 1, wherein determining an amount of cyclical shift comprises selecting the amount based on a mapping of the sequence and a plurality of symbol indexes to amounts of cyclical shift.

4. The method of claim 1, wherein the amount of cyclical shift in the one of the frequency domain and the time domain is based on a corresponding amount of shift in the other of the frequency domain and the time domain for the sequence.

5. The method of claim 1, wherein the amount of cyclical shift is based on the length and the root of the sequence.

6. The method of claim 1, wherein the sequence comprises an extended synchronization signal sequence.

7. A method of wireless communication, comprising:
receiving a sequence from a base station;
determining a symbol index where the sequence is received based on an amount of cyclical shift in one of a frequency domain and a time domain applied to the sequence, wherein the amount of cyclical shift is based on the sequence and the symbol index; and
synchronizing timing with the base station based on the determined symbol index.

8. The method of claim 7, wherein the sequence comprises a Zadoff-Chu sequence.

9. The method of claim 7, wherein determining the symbol index is based on a mapping of the sequence and a plurality of symbol indexes to amounts of cyclical shift.

10. The method of claim 7, wherein the amount of cyclical shift in the one of the frequency domain and the time domain is based on a corresponding amount of shift in the other of the frequency domain and the time domain for the sequence.

11. The method of claim 7, wherein the amount of cyclical shift is based on the length and the root of the sequence.

12. The method of claim 7, wherein the sequence comprises an extended synchronization signal sequence.

13. A base station, comprising:
a memory; and
a processor coupled to the memory, the processor being configured to:
determine a symbol index for transmitting a sequence;
determine an amount of cyclical shift in one of a frequency domain and a time domain to apply to the sequence, wherein the amount of cyclical shift is based on the sequence and the symbol index;
shift the sequence by the amount of cyclical shift; and
transmit the shifted sequence in a symbol corresponding to the symbol index.

14. The base station of claim 13, wherein the sequence comprises a Zadoff-Chu sequence.

15. The base station of claim 13, wherein determining an amount of cyclical shift comprises selecting the amount based on a mapping of the sequence and a plurality of symbol indexes to amounts of cyclical shift.

16. The base station of claim 13, wherein the amount of cyclical shift in the one of the frequency domain and the time domain is based on a corresponding amount of shift in the other of the frequency domain and the time domain for the sequence.

17. The base station of claim 13, wherein the amount of cyclical shift is based on the length and the root of the sequence.

18. The base station of claim 13, wherein the sequence comprises an extended synchronization signal sequence.

19. A user equipment, comprising:
a memory; and
a processor coupled to the memory, the processor being configured to:
receive a sequence from a base station;
determine a symbol index where the sequence is received based on an amount of cyclical shift in one of a frequency domain and a time domain applied to the sequence, wherein the amount of cyclical shift is based on the sequence and the symbol index; and
synchronize timing with the base station based on the determined symbol index.

20. The user equipment of claim 19, wherein the sequence comprises a Zadoff-Chu sequence.

21. The user equipment of claim 19, wherein determining the symbol index is based on a mapping of the sequence and a plurality of symbol indexes to amounts of cyclical shift.

22. The user equipment of claim 19, wherein the amount of cyclical shift in the one of the frequency domain and the time domain is based on a corresponding amount of shift in the other of the frequency domain and the time domain for the sequence.

23. The user equipment of claim 19, wherein the amount of cyclical shift is based on the length and the root of the sequence.

24. The user equipment of claim 19, wherein the sequence comprises an extended synchronization signal sequence.

25. A base station comprising:
means for determining a symbol index for transmitting a sequence;
means for determining an amount of cyclical shift in one of a frequency domain and a time domain to apply to the sequence, wherein the amount of cyclical shift is based on the sequence and the symbol index;
means for shifting the sequence by the amount of cyclical shift; and
means for transmitting the shifted sequence in a symbol corresponding to the symbol index.

26. The base station of claim 25, wherein the amount of cyclical shift in the one of the frequency domain and the time domain is based on a corresponding amount of shift in the other of the frequency domain and the time domain for the selected sequence.

27. The base station of claim 25, wherein the amount of cyclical shift is based on the length and the root of the selected sequence.

28. A user equipment comprising:
means for receiving a sequence from a base station;
means for determining a symbol index where the sequence is received based on an amount of cyclical shift in one of a frequency domain and a time domain applied to the sequence, wherein the amount of cyclical shift is based on the sequence and the symbol index; and
means for synchronizing timing with the base station based on the determined symbol index.

29. The user equipment of claim 28, wherein the amount of cyclical shift in the one of the frequency domain and the time domain is based on a corresponding amount of shift in the other of the frequency domain and the time domain for the sequence.

30. The user equipment of claim 28, wherein the amount of cyclical shift is based on the length and the root of the sequence.

31. A computer readable storage medium storing instructions that when executed by at least one processor cause the at least one processor to perform a method, the method comprising:
determining a symbol index for transmitting a sequence;
determining an amount of cyclical shift in one of a frequency domain and a time domain to apply to the sequence, wherein the amount of cyclical shift is based on the sequence and the symbol index;
shifting the sequence by the amount of cyclical shift; and
transmitting the shifted sequence in a symbol corresponding to the symbol index.

32. A computer readable storage medium storing instructions that when executed by at least one processor cause the at least one processor to perform a method, the method comprising:
receiving a sequence from a base station;
determining a symbol index where the sequence is received based on an amount of cyclical shift in one of a frequency domain and a time domain applied to the sequence, wherein the amount of cyclical shift is based on the sequence and the symbol index; and
synchronizing timing with the base station based on the determined symbol index.
